(19) United States
(12) Patent Application Publication
(10) Pub. No.: US 2003/0028422 A1
(43) Pub. Date: Feb. 6, 2003

(54) System for permitting a voter to make an educated choice among candidates

(76) Inventor: Robert Green, Bronx, NY (US)

Correspondence Address: Robert Green, 955 Evergreen Ave. #1807, Bronx, NY, 10473, US

(21) Appl. No.: 09/920,115

(22) Filed: Aug. 2, 2001

(51) Int. Cl. G06F 17/60

(52) U.S. Cl. 705/12

(57) ABSTRACT

A system for permitting a voter to make an educated choice among candidates that includes a single database that is partitioned into a first section, a second section, a third section, a fourth section, a fifth section, and a sixth section. The first section includes how laws are made. The second section includes bulletins and reports related to making the educated choice. The third section includes resumes of the candidates. The fourth section includes past and present performance of the candidates. The fifth section includes bills introduced by the candidates. The sixth section includes tracks of the bills introduced by the candidates. The system further includes first, second, and third apparatuses for allowing presentation, selection, and viewing of sections by the voter, respectively.

### BACKGROUND OF THE INVENTION

1. Field of the Invention

The present invention relates to a voting related system. More particularly, the present invention relates to a system for permitting a voter to make an educated choice among candidates.

2. Description of the Prior Art

Numerous innovations for voting systems have been provided in the prior art that will be described. Even though these innovations may be suitable for the specific individual purposes to which they address, however, they differ from the present invention.

FOR EXAMPLE, U.S. Pat. No. 5,377,099 to Miyagawa teaches an election terminal apparatus that incorporates a storage unit, a coordinate input unit and a two-dimensional display unit which is interlocked with the coordinate input unit. When voting is to be performed, the election terminal apparatus directly or indirectly displays candidate names or party names on the display unit, thus urging a voter to perform a selecting operation. When the voter selects a candidate by using the coordinate input unit, the election terminal apparatus displays the attribute of the selected candidate and urges the voter to perform a confirming operation to confirm a final decision. When the voter performs a confirming operation, the vote count data registered in the storage unit is updated.

ANOTHER EXAMPLE, U.S. Pat. No. 5,400,248 to Chisholm teaches a voting system that allows voters to express and cast votes that are conditional on the votes of others of a voting group. Votes may be conditional on the votes of specific individuals, on the number or percent of the overall group who vote a certain way, external events or on any combination thereof. The system solves the “common goods, free rider” dilemma in which voters oppose proposals they recognize as worthwhile out of fear that a few supporters will be burdened with all of the costs. The system specifies and enforces terms under which conditional voting will take place, and may manage the voting process across a network. The system recognizes when either multiple solutions or no solutions to a set of votes exist. The system can determine which voters are responsible for these cases, and can invite them to change their votes, if they wish. The system can also determine the largest subset or subsets of a group of conditional votes that has no solution, for which there is a unique solution or multiple solutions. Overall, the system leads to better and faster group decisions that are based on more complete voter knowledge than simply yes, no or abstain.

STILL ANOTHER EXAMPLE, U.S. Pat. No. 5,495,532 to Kilian et al. teaches a number-theoretic based algorithm that provides for secure electronic voting. A voter may cast a votes among n centers in a manner which prevents fraud and authenticates the votes. Preprocessing allows for nearly all of the communication and computation to be performed before any voting takes place. Each center can verify that each vote has been properly counted. The algorithm is based on families of homomorphic encryptions which have a partial compatibility property. The invention can be realized by current-generation PCs with access to an electronic bulletin board.

YET ANOTHER EXAMPLE, U.S. Pat. No. 6,092,051 to Kilian et al. teaches a number-theoretic based algorithm provides for secure receipt-free voting. A vote generating center generates a choice of votes for each voter or vote chooser. The votes are encrypted, shuffled, and conveyed to a vote chooser along with information regarding how the votes were shuffled without being intercepted en route. The information is preferably sent along untappable secure channels. The method can incorporate validation of generation and shuffling of the votes using chameleon commitment and interactive proofs. The invention can be realized by current-generation personal computers with untappable channels and access to an electronic bulletin board.

STILL YET EXAMPLE, U.S. Pat. No. 6,175,833 to West et al. teaches an online voting system that provides a standardized database architecture that integrates editorial and production processes. The voting system has a survey database to store multiple surveys and a server to serve the surveys over a network (e.g., the Internet) to readers. Each survey consists of one or more questions and multiple answer options per question. The voting system includes an authoring tool to permit an editor to construct the surveys. The surveys are stored in a predefined survey index tables. A display handler checks reader requests for pages that contain surveys, to determine whether the reader should receive a voting form or survey results. A vote handler processes votes cast by the readers in response to the surveys. Unique identifiers of voters who respond to the surveys are collected in a votes table. This table is checked when each vote is received to prevent readers from voting multiple times for a single survey. The vote handler tallies the votes cast for the answer options in a totals table. The survey index table also has fields to hold voting results for corresponding survey questions and answer options. The vote handler periodically updates these fields with the totals kept in the totals table. This update is automatic without intervention from the editors. The same index table holds the information to present the survey questions (to first time readers) and to show the results to the survey (to readers who have cast a vote). Over time, the editor may remove one or more questions or the entire survey from the survey index table. The surveys are archived, along with all of the voting data from the three tables, in persistent storage. After archival, the voting data for the removed surveys is automatically deleted from all three tables.

It is apparent that numerous innovations for voting systems have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a system for permitting a voter to make an educated choice among candidates that avoids the disadvantages of the prior art.

ANOTHER OBJECT of the present invention is to provide a system for permitting a voter to make an educated choice among candidates that is simple to use.

BRIEFLY STATED, STILL ANOTHER OBJECT of the present invention is to provide a system for permitting a voter to make an educated choice among candidates that includes a single database that is partitioned into a first section, a second section, a third section, a fourth section, a fifth section, and a sixth section. The first section includes how laws are made. The second section includes bulletins and reports related to making the educated choice. The third section includes resumes of the candidates. The fourth section includes past and present performance of the candidates. The fifth section includes bills introduced by the candidates. The sixth section includes tracks of the bills introduced by the candidates. The system further includes first, second, and third apparatuses for allowing presentation, selection, and viewing of sections by the voter, respectively.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1V are a system diagram of the present invention.

### LIST OF REFERENCE NUMERALS UTILIZED IN THE DRAWING

10 system of present invention for permitting voter 12 to make educated choice 14 among candidates 16

12 voter

14 educated choice

16 candidates

18 single database

19 first section of single database 18 including how laws 20 are made

20 laws

22 second section of single database 18 including bulletins 24 and reports 26 related to making educated choice 14

24 bulletins

26 reports

28 third section of single database 18 including resumes 30 of candidates 16

30 resumes of candidates 16

32 fourth section of single database 18 including past and present performance 34 of candidates 16

34 past and present performance of candidates 16

36 fifth section of single database 18 including bills introduced 38 by candidates 16

38 bills introduced by candidates 16

40 sixth section of single database 18 including tracks of bills introduced 38 by candidates 16 including who is pushing bills introduced 38 and who is holding bills introduced 38 up

42 first apparatus for presenting first section 18, second section 22, third section 28, fourth section 32, fifth section 36, and sixth section 40 of single database 18 to voter 12

44 print of first apparatus 42

46 radio of first apparatus 42

48 TV of first apparatus 42

50 telecommunications of first apparatus 42

52 CD-rom of first apparatus 42

54 computer disc of first apparatus 42

56 facsimile of first apparatus 42

58 e-mail of first apparatus 42

60 Internet of first apparatus 42

62 newspapers of print 44 of first apparatus 42

64 magazines of print 44 of first apparatus 42

66 periodicals of print 44 of first apparatus 42

68 newsletters of print 44 of first apparatus 42

70 inserts of print 44 of first apparatus 42

72 news stations of radio 46 of first apparatus 42

74 public service announcements of radio 46 of first apparatus 42

76 PBS of TV 48 of first apparatus 42

78 Public Access Channels of TV 48 of first apparatus 42

80 national of telecommunications 50 of first apparatus 42

82 statewide of telecommunications 50 of first apparatus 42

84 local of telecommunications 50 of first apparatus 42

86 second apparatus for allowing selection of specific section 88 of first section 18, second section 22, third section 28, fourth section 32, fifth section 36, and sixth section 40 of single database 18 by voter 12 so as to form selected database 90

88 specific section of first section 18, second section 22, third section 28, fourth section 32, fifth section 36, and sixth section 40 of single database 18

90 selected section of single database 90

92 third apparatus for allowing viewing of selected section 90 of single database 18 by voter 12

### DETAILED DESCRIPTION OF THE PREFERRED EMBODIMENT

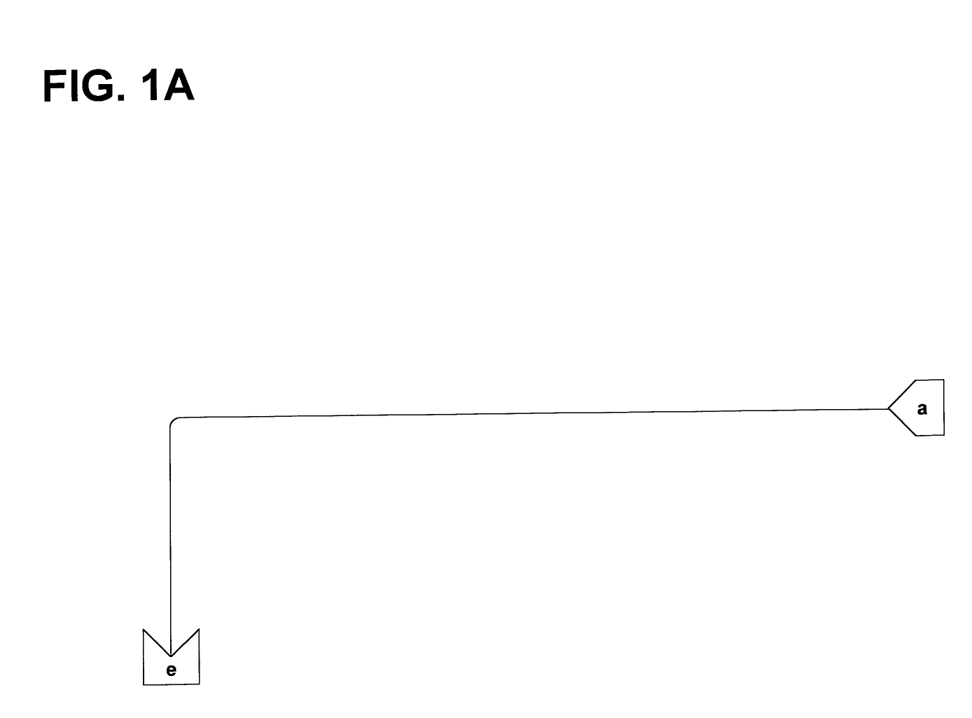

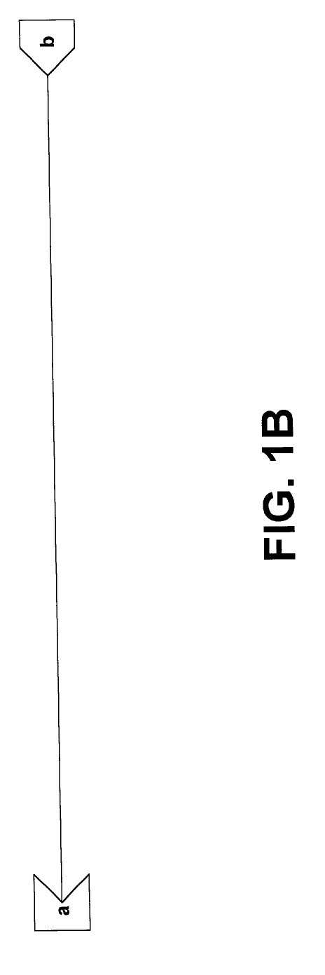

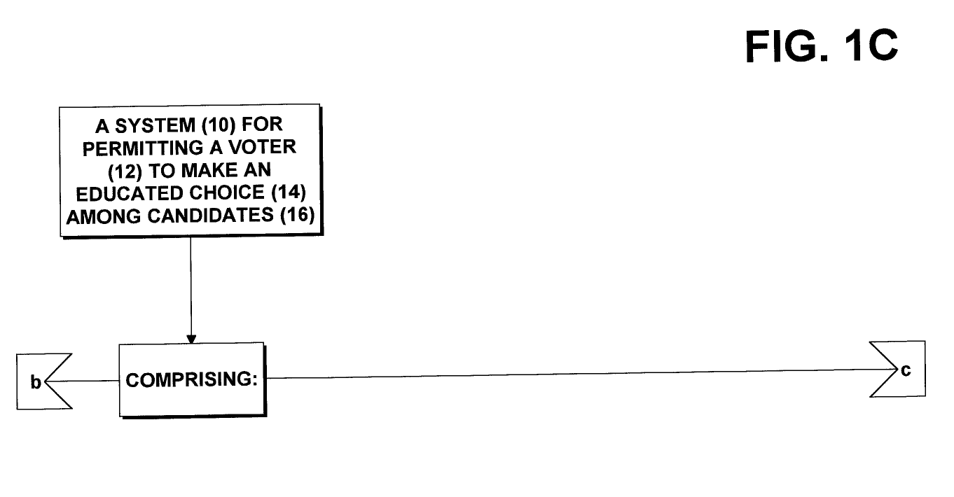

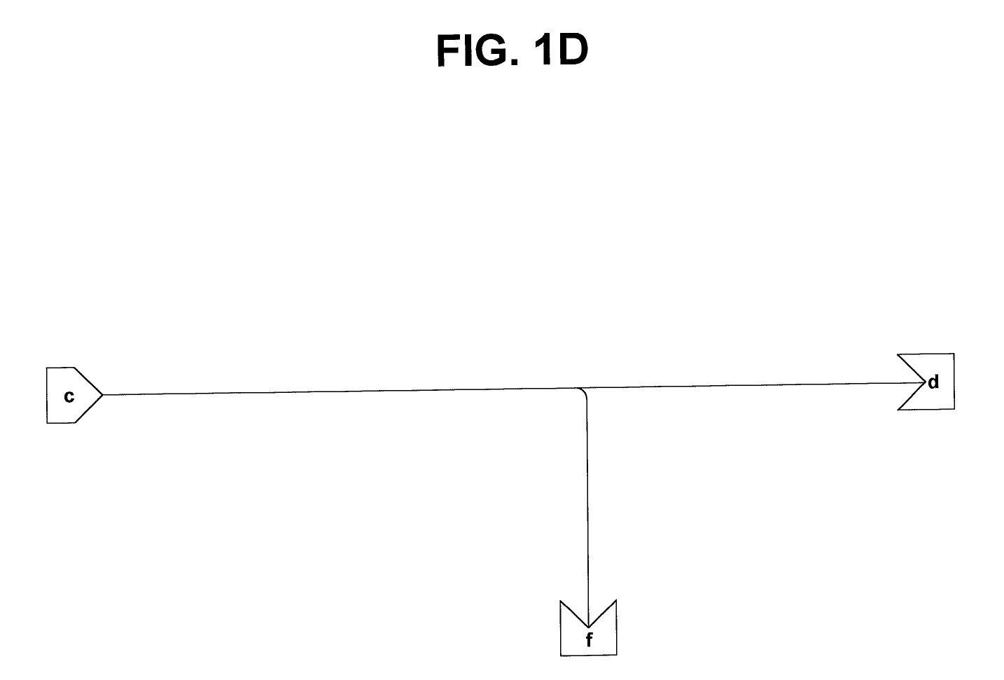

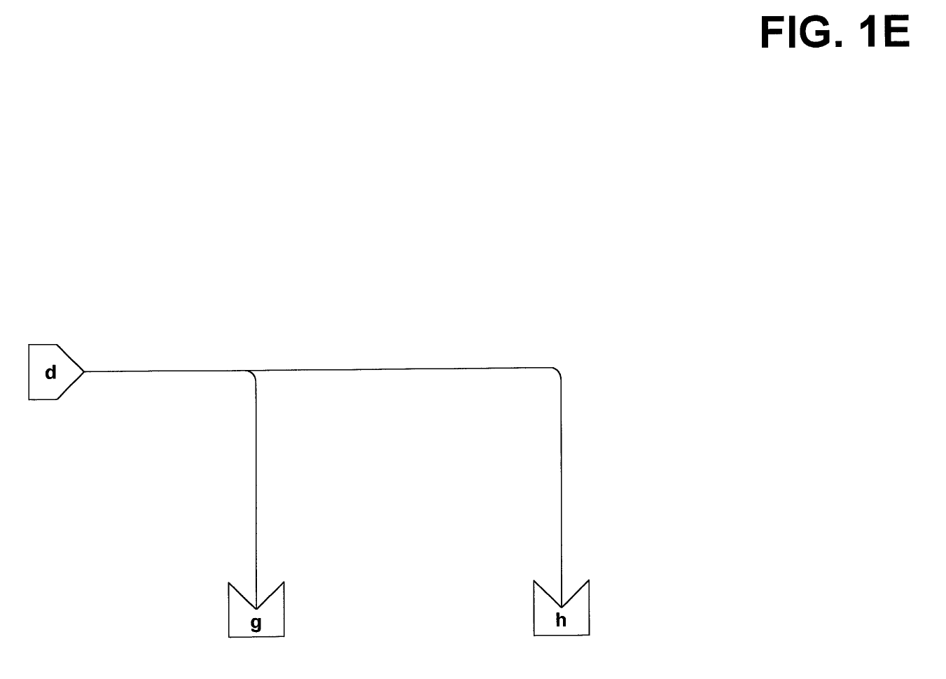

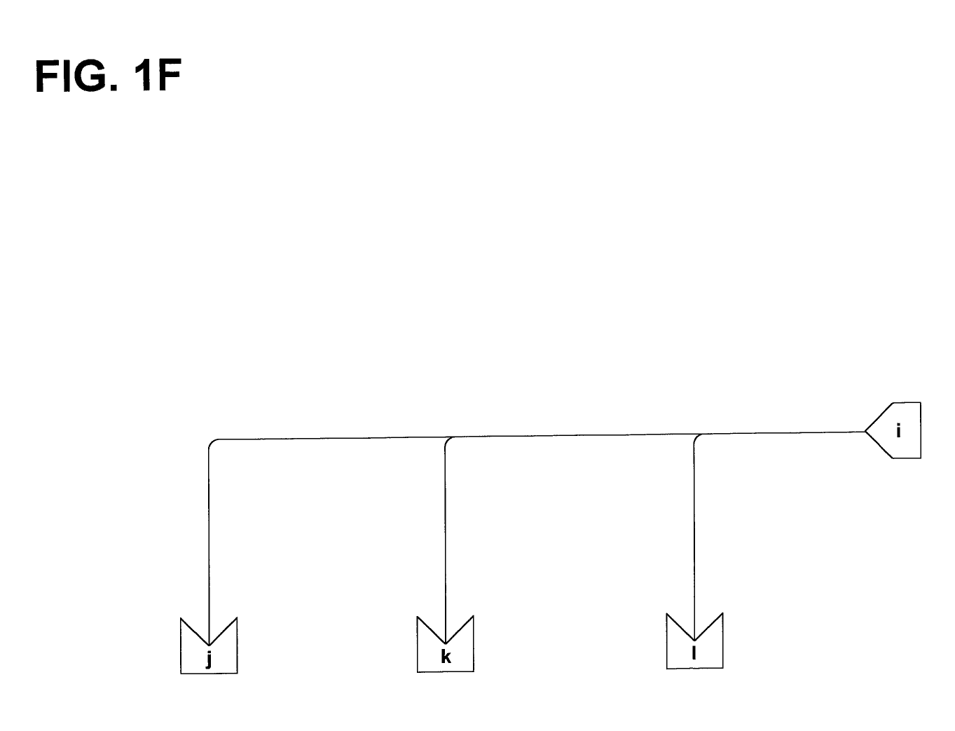

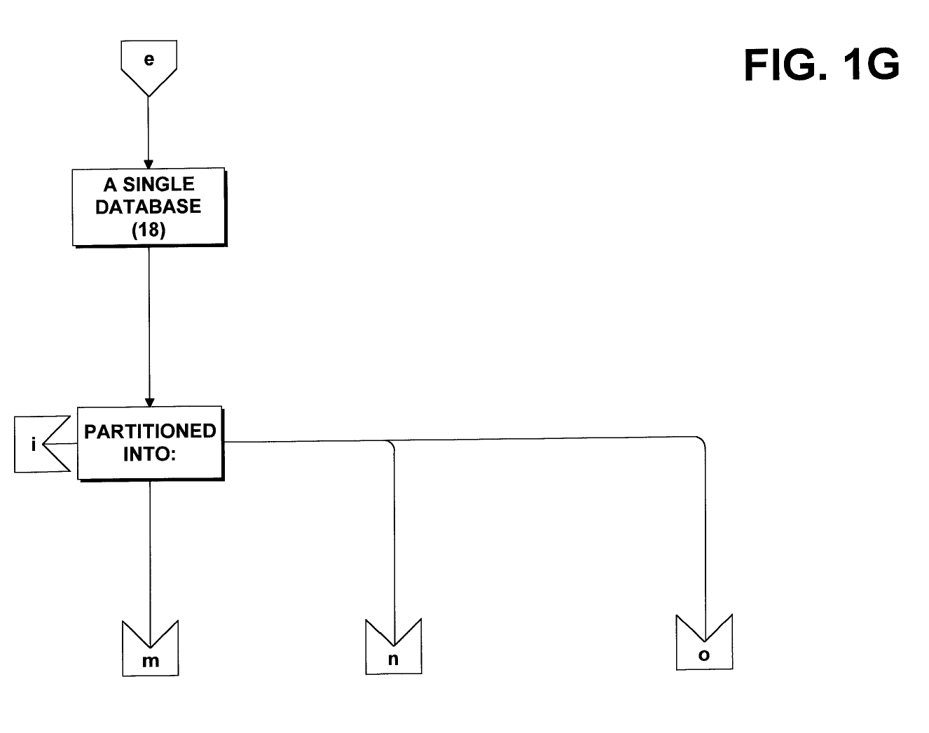

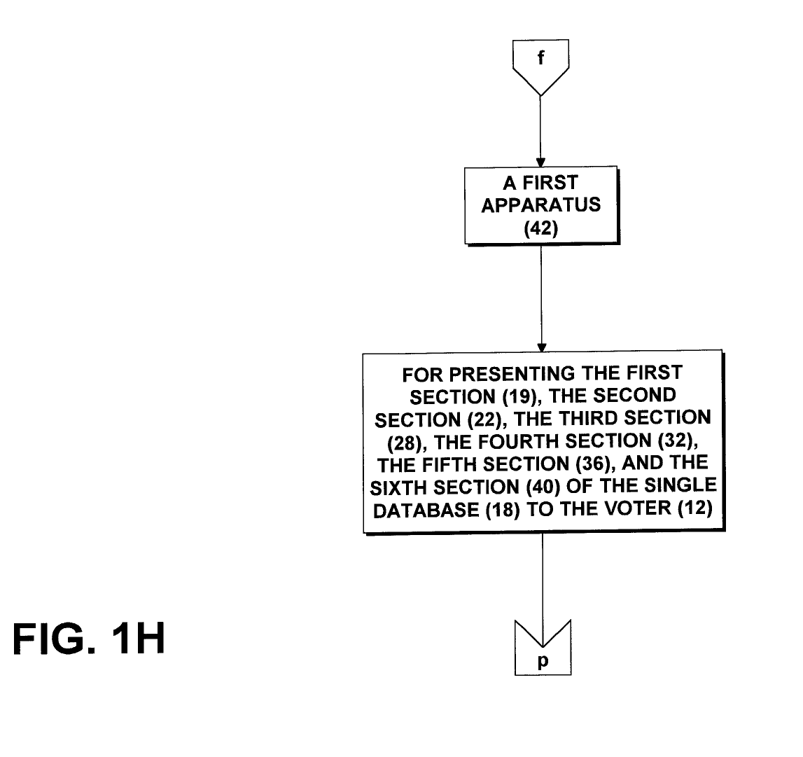

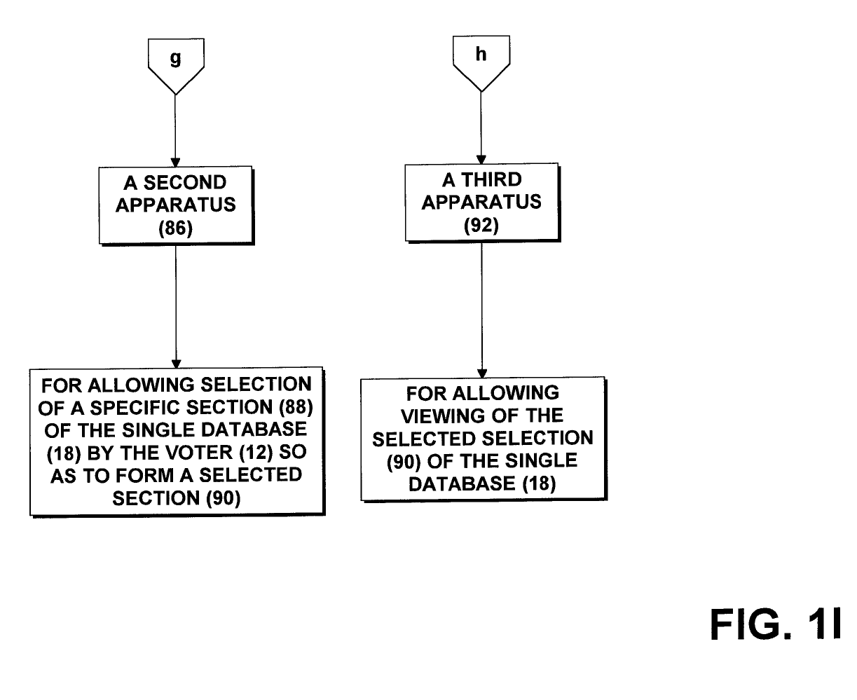

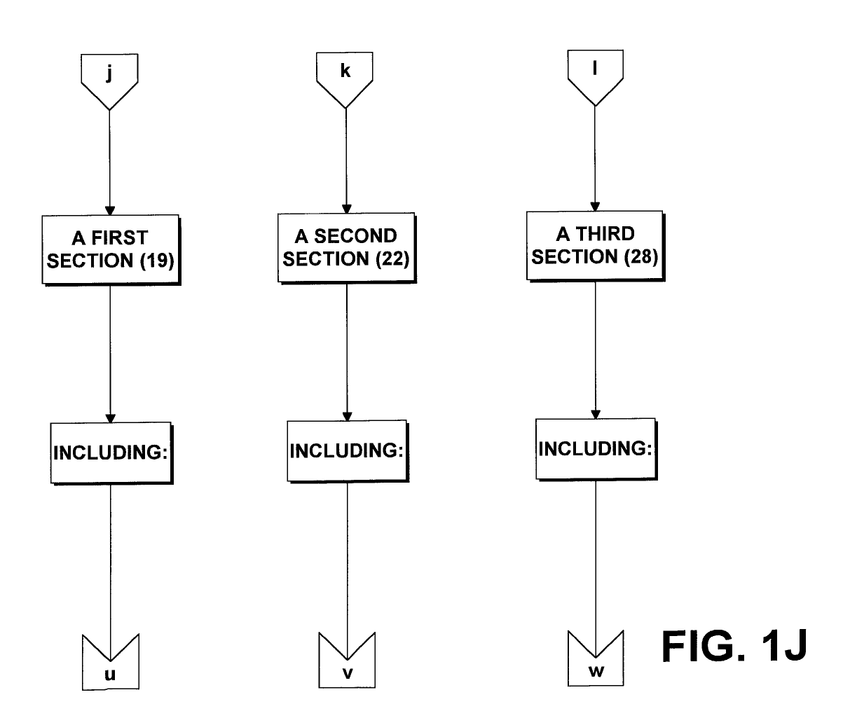

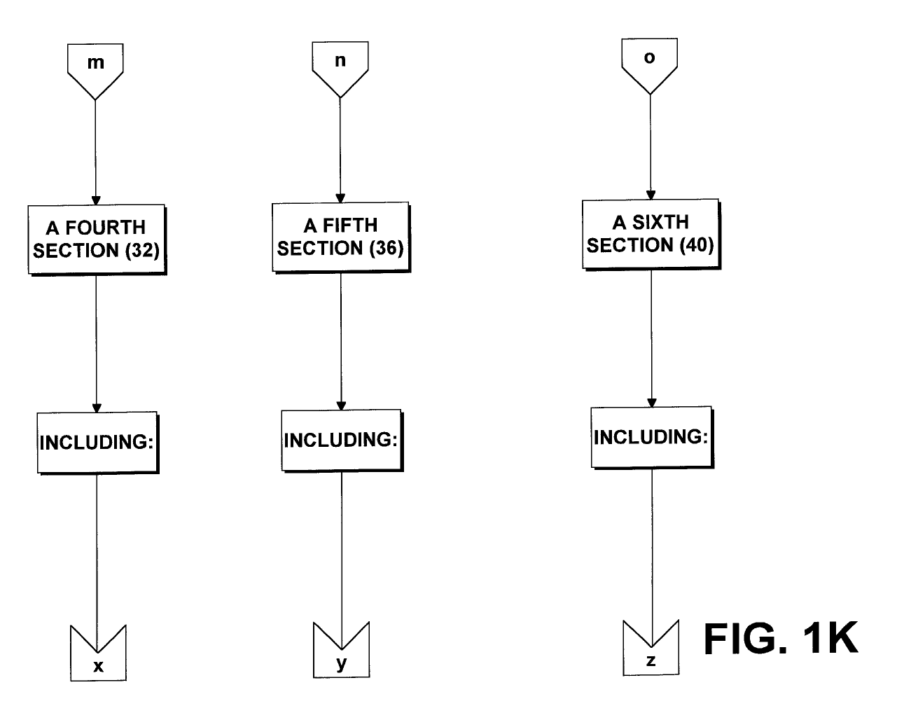

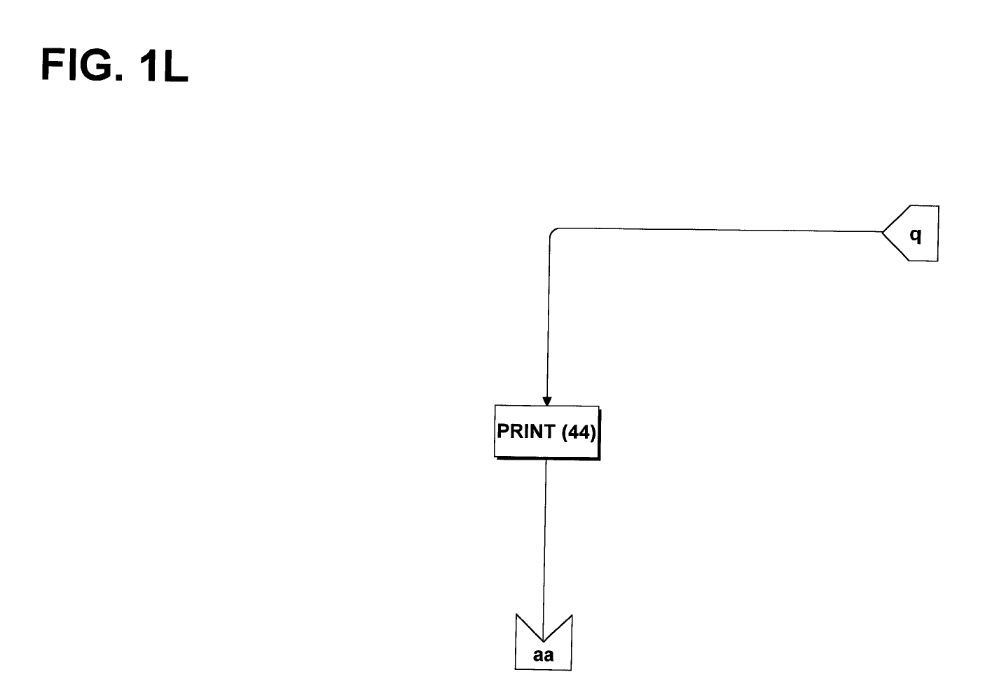

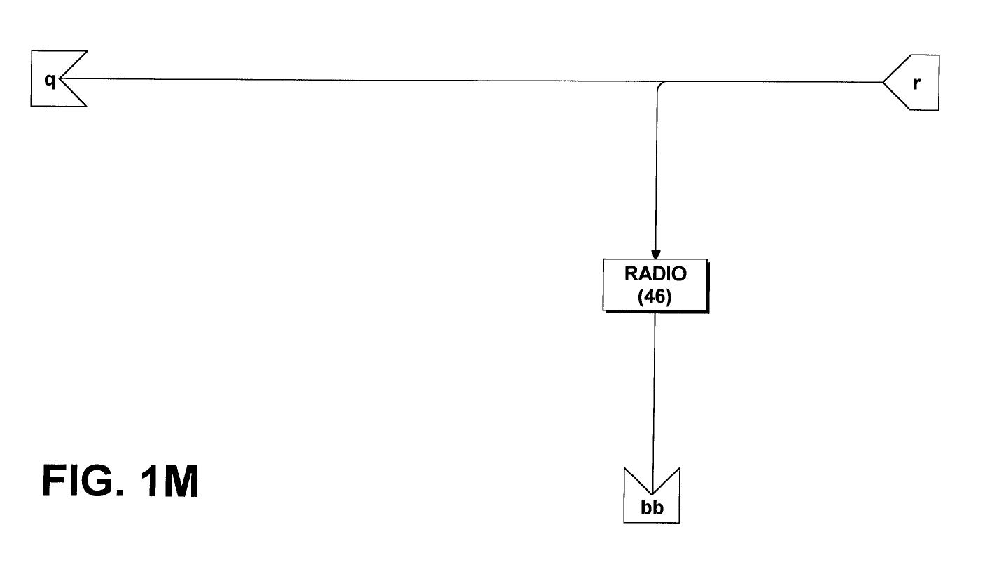

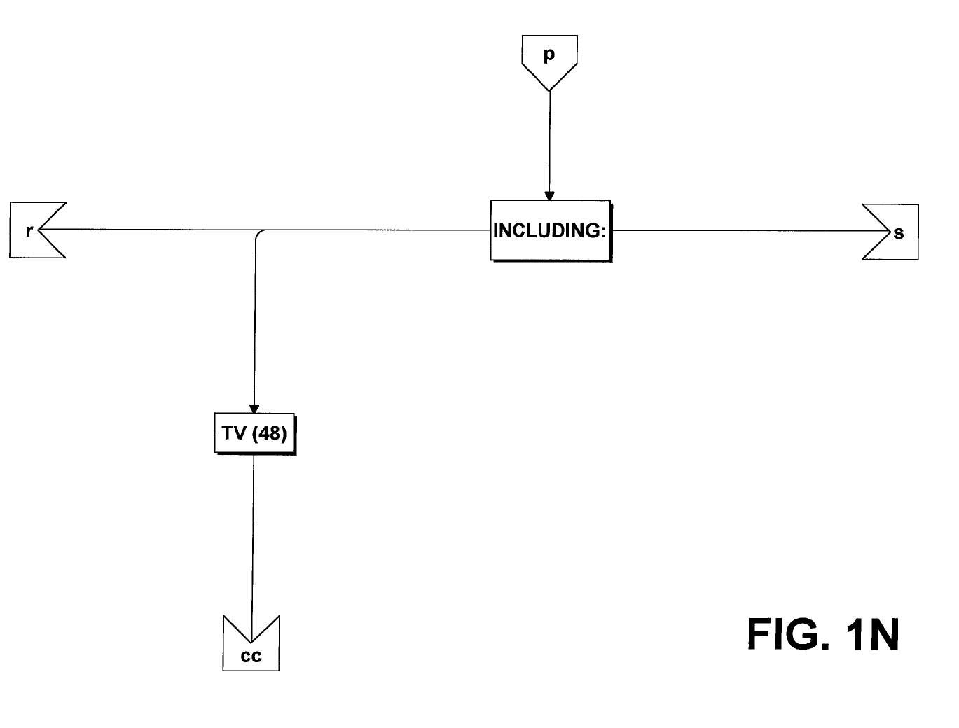

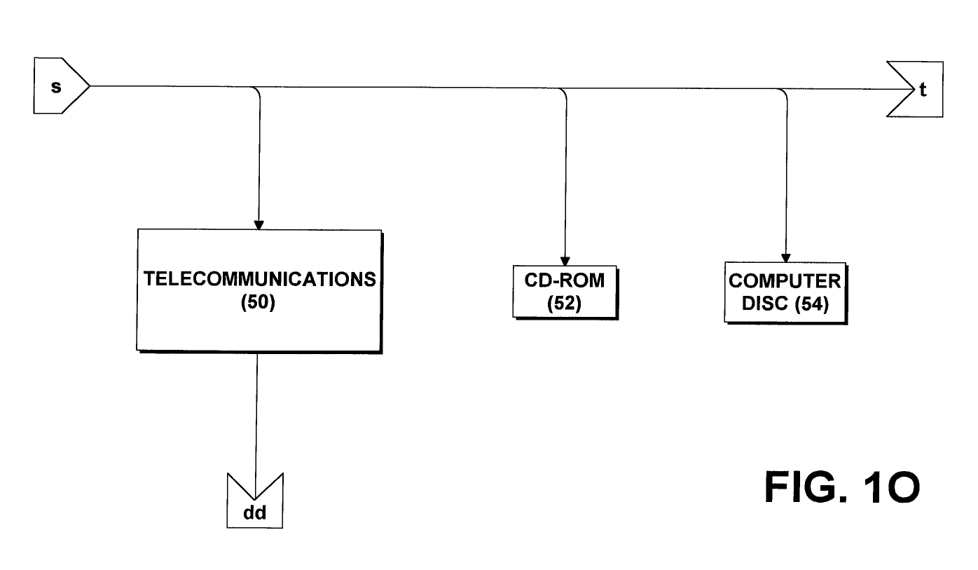

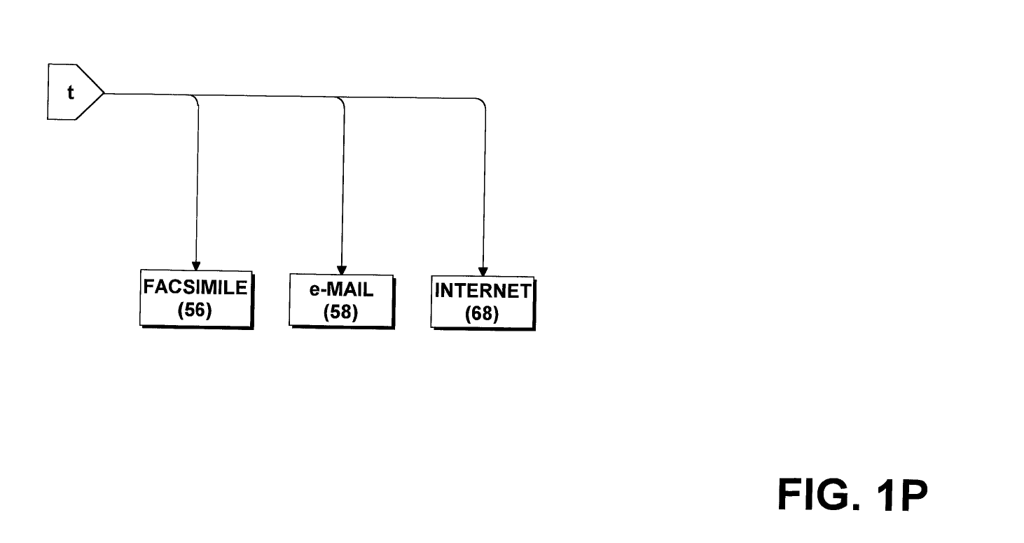

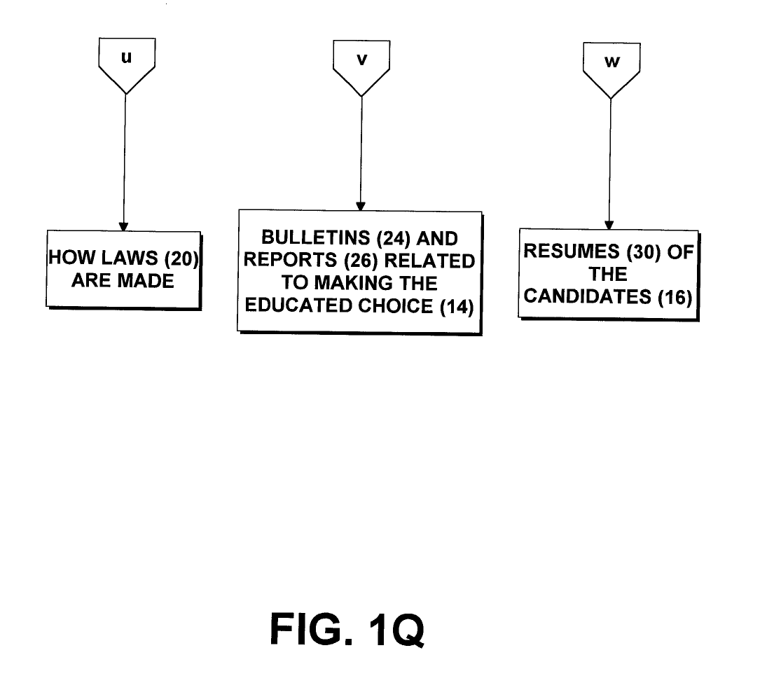

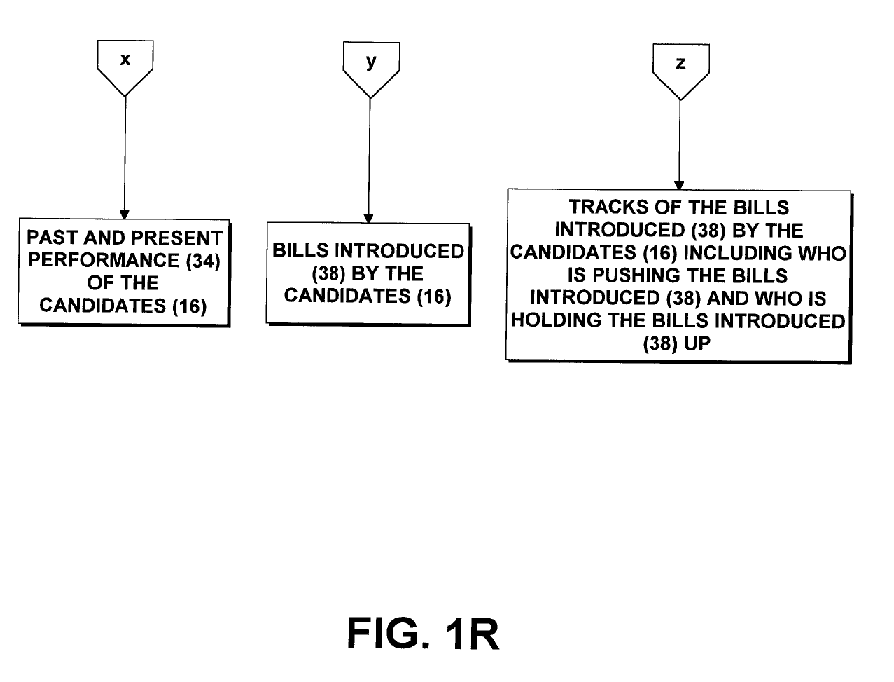

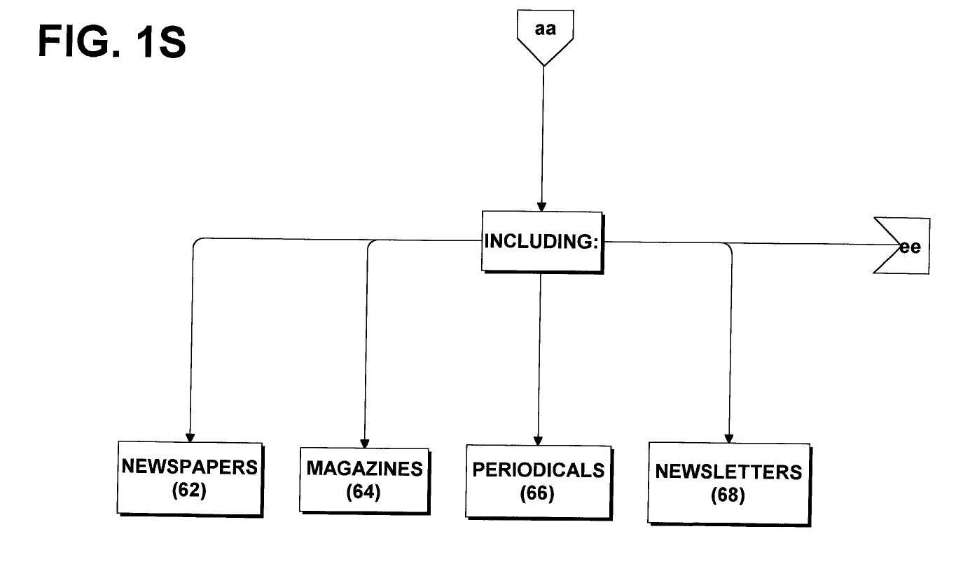

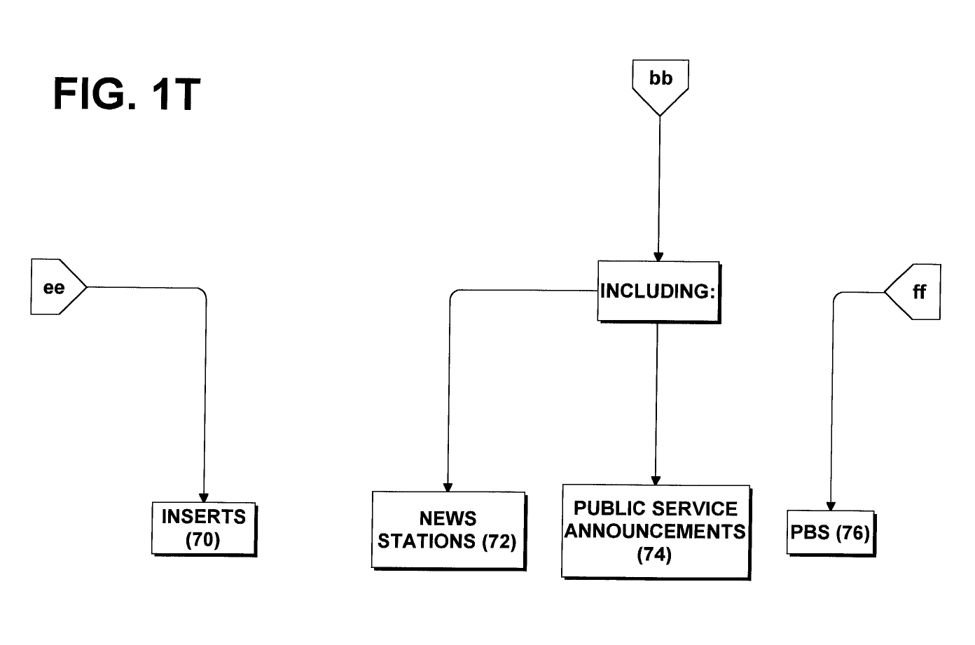

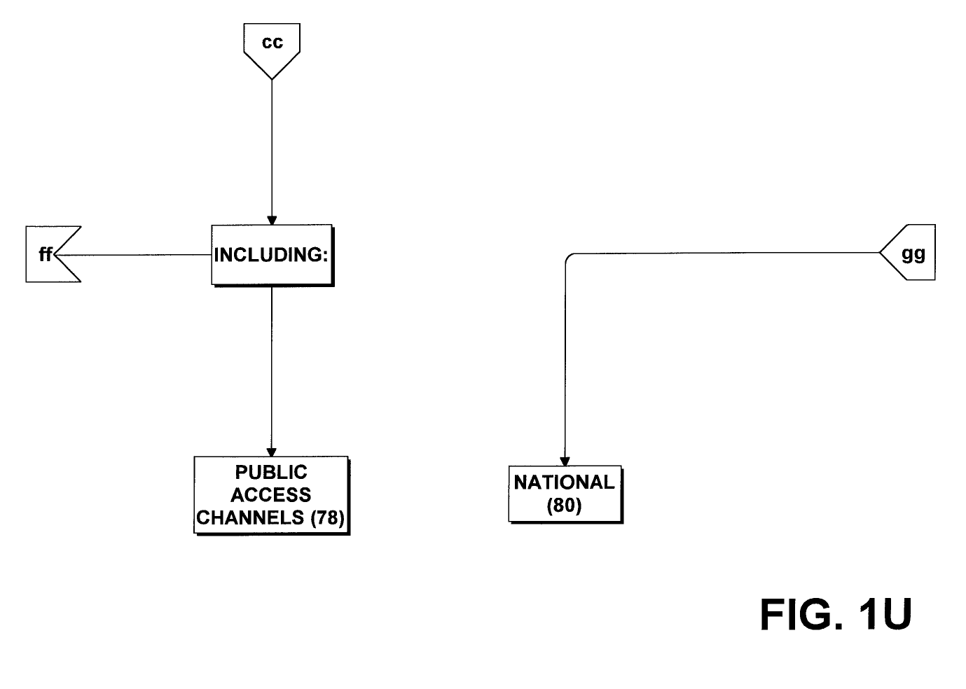

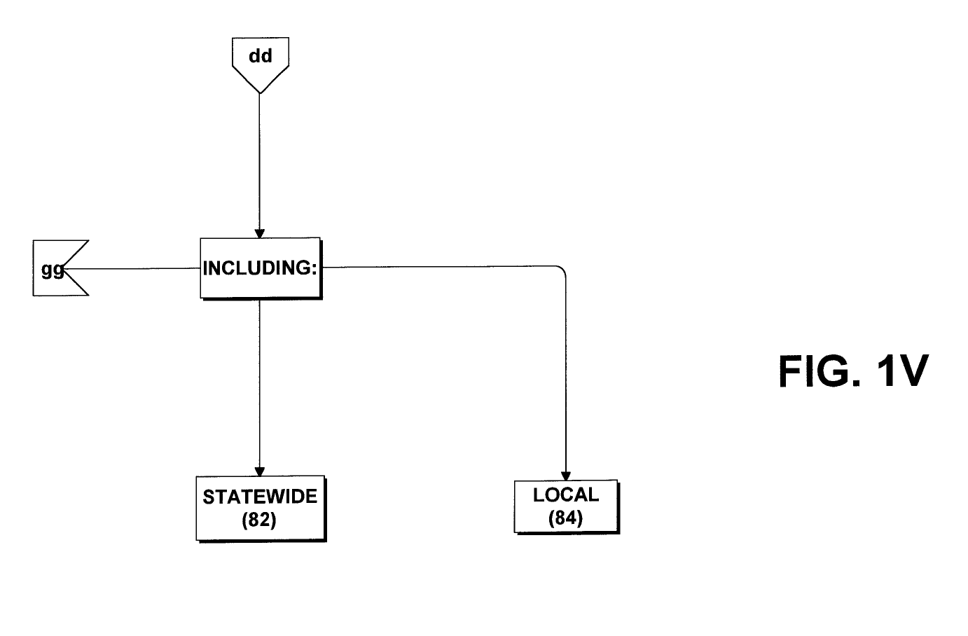

Referring now to the figures, in which like numerals indicate like parts, and particularly to FIGS. 1A-1zz, which are a system diagram of the present invention, the system of the present invention is shown generally at 10 for permitting a voter 12 to make an educated choice 14 among candidates 16.

The system 10 comprises a single database 18 that is partitioned into a first section 19 that includes how laws 20 are made, a second section 22 that includes bulletins 24 and reports 26 related to making the educated choice 14, a third section 28 that includes resumes 30 of the candidates 16, a fourth section 32 that includes past and present performance 34 of the candidates 16, a fifth section 36 that includes bills introduced 38 by the candidates 16, and a sixth section 40 that includes tracks of the bills introduced 38 by the candidates 16 that includes who is pushing the bills introduced 38 and who is holding the bills introduced 38 up.

The system further 10 comprises a first apparatus 42 for presenting the first section 19, the second section 22, the third section 28, the fourth section 32, the fifth section 36, and the sixth section 40 of the single database 18 to the voter 12.

The first apparatus 42 includes print 44, radio 46, TV 48, telecommunications 50, CD-Rom 52, computer disc 54, facsimile 56, e-mail 58, and Internet 60.

The print 44 of the first apparatus 42 includes newspapers 62, magazines 64, periodicals 66, newsletters 68, and inserts 70, the radio 46 of the first apparatus 42 includes news stations 72 and public service announcements 74, the TV 48 of the first apparatus 42 includes PBS 76 and Public Access Channels 78, and the telecommunications 50 of the first apparatus 42 includes national 80, statewide 82, and local 84.

The system further 10 comprises a second apparatus 86 for allowing selection of a specific section 88 of the first section 19, the second section 22, the third section 28, the fourth section 32, the fifth section 36, and the sixth section 40 of the single database 18 by the voter 12 so as to form a selected section 90, and a third apparatus 92 for allowing viewing of the selected section 90 of the single database 18 by the voter 12.

It will be understood that each of the elements described above, or two or more together, may also find a useful application in other types of constructions differing from the types described above.

While the invention has been illustrated and described as embodied in a system for permitting a voter to make an educated choice among candidates, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A system for permitting a voter to make an educated choice among candidates, comprising:
a single database partitioned into:
a) a first section;
b) a second section;
c) a third section;
d) a fourth section;
e) a fifth section; and
f) a sixth section;
wherein said first section includes how laws are made;
wherein said second section includes bulletins and reports related to making the educated choice;
wherein said third section includes resumes of the candidates;
wherein said fourth section includes past and present performance of the candidates;
wherein said fifth section includes bills introduced by the candidates; and
wherein said sixth section includes tracks of the bills introduced by the candidates that includes who is pushing the bills introduced and who is holding the bills introduced up.

2. The system as defined in claim 1, further comprising first means for presenting said first section, said second section, said third section, said fourth section, said fifth section, and said sixth section of said single database to the voter.

3. The system as defined in claim 2, wherein said first means includes print.

4. The system as defined in claim 2, wherein said first means includes radio.

5. The system as defined in claim 2, wherein said first means includes TV.

6. The system as defined in claim 2, wherein said first means includes telecommunications.

7. The system as defined in claim 2, wherein said first means includes CD-Rom.

8. The system as defined in claim 2, wherein said first means includes computer disc.

9. The system as defined in claim 2, wherein said first means includes facsimile.

10. The system as defined in claim 2, wherein said first means includes e-mail.

11. The system as defined in claim 2, wherein said first means includes Internet.

12. The system as defined in claim 3, wherein said print includes newspapers, magazines, periodicals, newsletters, and inserts.

13. The system as defined in claim 4, wherein said radio includes news stations and public service announcements.

14. The system as defined in claim 5, wherein said TV includes PBS and Public Access Channels.

15. The system as defined in claim 6, wherein said telecommunications includes national, statewide, and local.

16. The system as defined in claim 1, further comprising second means for allowing selection of a specific section of said first section, said second section, said third section, said fourth section, said fifth section, and said sixth section of said single database by the voter so as to form a selected section of said single database.

17. The system as defined in claim 16, further comprising third means for allowing viewing of said selected section of said single database by the voter.
